(19) United States
(12) Patent Application Publication
(10) Pub. No.: US 2025/0214486 A1
(43) Pub. Date: Jul. 3, 2025

(54) CONTROL DEVICE AND VEHICLE

(71) Applicant: TOYOTA JIDOSHA KABUSHIKI KAISHA, Toyota-shi (JP)

(72) Inventor: Hirotaka SASAKI, Nagoya-shi (JP)

(73) Assignee: TOYOTA JIDOSHA KABUSHIKI KAISHA, Toyota-shi (JP)

(21) Appl. No.: 18/902,991

(22) Filed: Oct. 1, 2024

(30) Foreign Application Priority Data
Dec. 28, 2023 (JP) 2023-222400

(51) Int. Cl. B60L 58/24

(52) U.S. Cl. CPC B60L 58/24; B60L 2240/545; B60L 2240/62; B60L 2260/56

(57) ABSTRACT

An ECU (control device) includes a terminal (first acquisition unit) for acquiring information (information based on a first time) for calculating an arrival required time until a time at which charging is predicted to be executed, and a terminal (second acquisition unit) for acquiring information (information based on a second time) for calculating a temperature adjustment required time required for adjusting a temperature of the power storage device (battery) to an appropriate temperature for charging. When the length of the arrival required time (first time) is equal to or less than the length of the temperature adjustment required time (second time), ECU starts adjusting the temperature of the power storage device so that the temperature of the power storage device becomes the appropriate temperature.

### CROSS-REFERENCE TO RELATED APPLICATION

This application claims priority to Japanese Patent Application No. 2023-222400 filed on Dec. 28, 2023, incorporated herein by reference in its entirety.

### BACKGROUND

### 1. Technical Field

The present disclosure relates to a control device and a vehicle.

### 2. Description of Related Art

Japanese Unexamined Patent Application Publication No. 2009-044887 (JP 2009-044887 A) discloses a vehicle including a power storage device and a control device. The control device manages the temperature of the power storage device so that the power storage device is at a temperature suitable for charging when the vehicle arrives at a destination.

### SUMMARY

In JP 2009-044887 A, the timing to start the temperature adjustment of the power storage device (battery) is not taken into consideration. For this reason, it is conceivable that the time period during which the temperature adjustment is performed becomes excessively long due to the temperature adjustment of the power storage device being started early, for example. In this case, deterioration of the electric efficiency or the like may occur.

The present disclosure has been made to address the above issue, and an object thereof is to provide a control device and a vehicle capable of starting temperature adjustment of a battery at an appropriate timing.

A first aspect of the present disclosure provides a control device that controls a vehicle equipped with a chargeable battery, including:
a first acquisition unit that acquires information based on a first time until a time at which execution of charging is predicted; and
a second acquisition unit that acquires information based on a second time required to adjust a temperature of the battery to an appropriate temperature that is appropriate for the charging. The control device causes the vehicle to start temperature adjustment of the battery so that the temperature of the battery becomes the appropriate temperature when a length of the first time based on the information acquired by the first acquisition unit is equal to or less than a length of the second time based on the information acquired by the second acquisition unit.

As described above, the control device according to the first aspect of the present disclosure causes the vehicle to start temperature adjustment of the battery so that the temperature of the battery becomes an appropriate temperature when the length of the first time is equal to or less than the length of the second time. Thus, it is possible to suppress the temperature adjustment of the battery being started when the first time until the charging is started is longer than the second time required to adjust the temperature of the battery to an appropriate temperature. As a result, it is possible to suppress the temperature adjustment of the battery being performed for an excessively (unnecessarily) long period. Therefore, with the above-described configuration, the temperature adjustment of the battery can be started at an appropriate timing.

In the control device according to the first aspect,
preferably, the vehicle is caused to stop the temperature adjustment when the length of the first time becomes greater than a total length of the second time and a predetermined time due to a change in the length of the first time after the temperature adjustment is started. With this configuration, it is possible to suppress the temperature adjustment of the battery being continued when the temperature adjustment of the battery becomes unnecessary due to the change (increase) in the length of the first time after the temperature adjustment is started. As a result, it is possible to further suppress a decrease in the electric efficiency.

In the control device according to the first aspect, preferably,
the vehicle is caused to start the temperature adjustment again when the length of the first time becomes equal to or less than the length of the second time again after the temperature adjustment is completed. With this configuration, the temperature adjustment of the battery can be started at an appropriate timing even when the temperature adjustment is required again after the temperature adjustment is completed.

In the control device according to the one aspect, preferably,
the first time includes information on a time required for the vehicle to reach a facility capable of the charging. With this configuration, it is possible to easily start the temperature adjustment of the battery at an appropriate timing based on the time required for the vehicle to reach the facility capable of charging.

A second aspect of the present disclosure provide a vehicle including:
a chargeable battery; and
the control device according to the first aspect. Accordingly, it is possible to provide a vehicle capable of starting the temperature adjustment of the battery at an appropriate timing.

According to the present disclosure, it is possible to start temperature adjustment of a battery mounted in a vehicle at an appropriate timing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an electrified vehicle according to an embodiment;

FIG. 2 is a diagram illustrating a configuration of an ECU of an electrified vehicle according to an embodiment;

FIG. 3 is a flowchart illustrating control of an ECU of an electrified vehicle according to one embodiment;

FIG. 4 is a diagram illustrating a change between an arrival required time and a temperature control required time when the temperature adjustment of the power storage device is completed in the middle;

FIG. 5 is a diagram illustrating a change between an arrival required time and a temperature control required time when a length of an arrival required time is larger than a total length of a temperature control required time and a predetermined time; and

FIG. 6 is a diagram illustrating an electrified vehicle and a server according to a modification of the embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### Configuring Electrified Vehicle

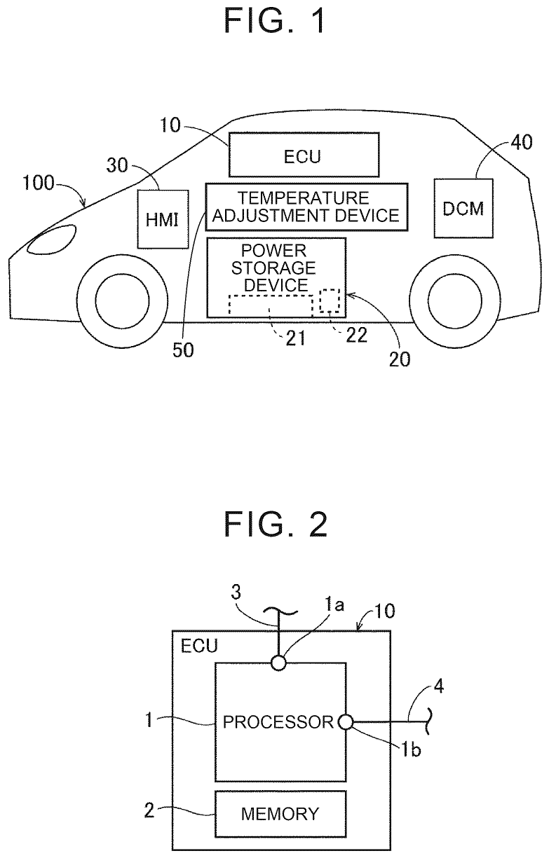

FIG. 1 is a diagram illustrating a configuration of an electrified vehicle 100 including an electronic control unit (ECU) 10 according to the present embodiment. ECU 10 and electrified vehicle 100 are exemplary “control devices” and “vehicles” of the present disclosure, respectively.

Electrified vehicle 100 include, for example, a plug-in hybrid electric vehicle (PHEV), a battery electric vehicle (BEV), or a fuel cell electric vehicle (FCEV).

In addition to ECU 10, electrified vehicle 100 includes a power storage device 20, a human machine interface (HMI) device 30, a data communication module (DCM) 40, and a temperature adjustment device 50. Note that the power storage device 20 is an example of a “battery” of the present disclosure.

ECU 10 is a device that controls electrified vehicle 100. ECU 10 is in communication with respective devices (ECU) and the like in electrified vehicle 100 by, for example, a controller area network (CAN) communication. Thus, ECU 10 receives various types of data from the devices in electrified vehicle 100. The detailed configuration of ECU 10 will be described later.

The power storage device 20 (a power storage cell 21 to be described later) stores electric power used for driving (for example, traveling) electrified vehicle 100. The power storage device 20 can be charged in a chargeable facility (a charging station, a charging station, a dealer, and the like) installed in each place.

The power storage device 20 includes a power storage cell 21 and a temperature sensor 22. The temperature sensor 22 detects the temperature of the power storage cell 21. The temperature sensor 22 may be provided outside the power storage device 20.

HMI device 30 includes a car navigation device and the like. The car navigation device is capable of displaying the present position of electrified vehicle 100 and searching for a route to a destination (transit point). In addition, the car navigation device can acquire information on a distance to a destination (a waypoint). HMI device 30 communicates with ECU 10 by CAN communication or the like.

DCM 40 can communicate with communication devices (servers, smart centers, etc.) external to electrified vehicle 100. Thus, ECU 10 can acquire data from the outside through DCM 40.

The temperature adjustment device 50 is a device for adjusting the temperature of the power storage device 20. The temperature adjustment device 50 includes a device (for example, a heater) for raising the temperature of the power storage device 20. The temperature adjustment device 50 may include a refrigerant circuit, a switching valve, and the like for exchanging heat between the power storage device 20 and the refrigerant that has been heated by heat of a drive unit or the like in electrified vehicle 100. Further, the temperature adjustment device 50 may include a device (for example, a radiator, a blower, and the like) that cools the power storage device 20.

FIG. 2 is a diagram illustrating a detailed configuration of ECU 10. ECU 10 includes a processor 1 and memories 2.

In the memory 2, information (for example, a map, a mathematical expression, and various parameters) used in the program is stored in addition to the program executed by the processor 1.

The processor 1 is provided with a terminal 1a and a terminal 1b. The terminal 1a is connected to the wire 3 from the outside of ECU 10. A wire 4 from the outside of ECU 10 is connected to the terminal 1b. Note that the terminal 1a and the terminal 1b are exemplary “first acquisition unit” and “second acquisition unit” of the present disclosure, respectively.

The terminal 1a receives, for example, data from HMI device 30 through the wire 3. The information from HMI device 30 includes information for calculating a time until a time at which the power storage device 20 is expected to be charged. The information includes information on a distance between electrified vehicle 100 and a rechargeable facility set at a destination or a waypoint, velocity information of an electrified vehicle 100, traffic information, and the like. Note that the information for calculating the time until the 30 time at which the execution of the charging is predicted is an example of “information based on the first time” of the present disclosure.

In the present embodiment, the time until the time at which the power storage device 20 is expected to be charged is the time required for electrified vehicle 100 to arrive at the chargeable facilities set at the destination or the waypoint (hereinafter referred to as the time required for arrival). The processor 1 calculates the time-to-arrive based on the information acquired by the terminal 1a. Note that the arrival time is an example of the “first time” of the present disclosure.

For example, data from the power storage device 20 is inputted to the terminal 1b through the wire 4. The information from the power storage device 20 includes information for calculating a time (hereinafter, referred to as a temperature adjustment required time) required to adjust the temperature of the power storage device 20 to a temperature suitable for charging (hereinafter, referred to as an appropriate temperature) (for example, 35° C.). The processor 1 calculates the required temperature control time based on the information acquired by the terminal 1b. The information inputted to the terminal 1b includes information on the present temperature of the power storage device 20 (a detected value of the temperature sensor 22), information on the outside air temperature, an output of the temperature adjustment device 50, and predicted information on the change in the air temperature (weather), and the like. Note that the information on the appropriate temperature may be stored in the memory 2 in advance, or may be appropriately calculated by the processor 1 on the basis of information on the outside air temperature or the like. The information for calculating the required temperature control time is an example of “information based on the second time” of the present disclosure. Further, the time required for temperature control is an example of the “second time” of the present disclosure.

Note that the configuration of ECU 10 is not limited to the above-described embodiment. For example, the processor 1 may receive the above-described data from HMI device 30, the power storage device 20, and the like by radio communication.

Here, in the conventional electrified vehicle, the power storage device may be temperature adjustment at an inappropriate timing. For example, the temperature adjustment of the power storage device may be started early. It is conceivable that the power consumption of electrified vehicle is deteriorated due to an excessively long period in which the thermal regulation is performed.

Therefore, in the present embodiment, when the arrival required time calculated by the processor 1 is equal to or less than the length of the temperature adjustment required time calculated by the processor 1, ECU 10 (processor 1) starts adjusting the temperature of the power storage device 20 so that the temperature of the power storage device 20 becomes an appropriate temperature. Specifically, ECU 10 (processor 1) starts the temperature adjustment by controlling the temperature adjustment device 50 (for example, turning ON the heaters) when the arrival required time is equal to or less than the length of the temperature adjustment required time.

### ECU Control Flowchart

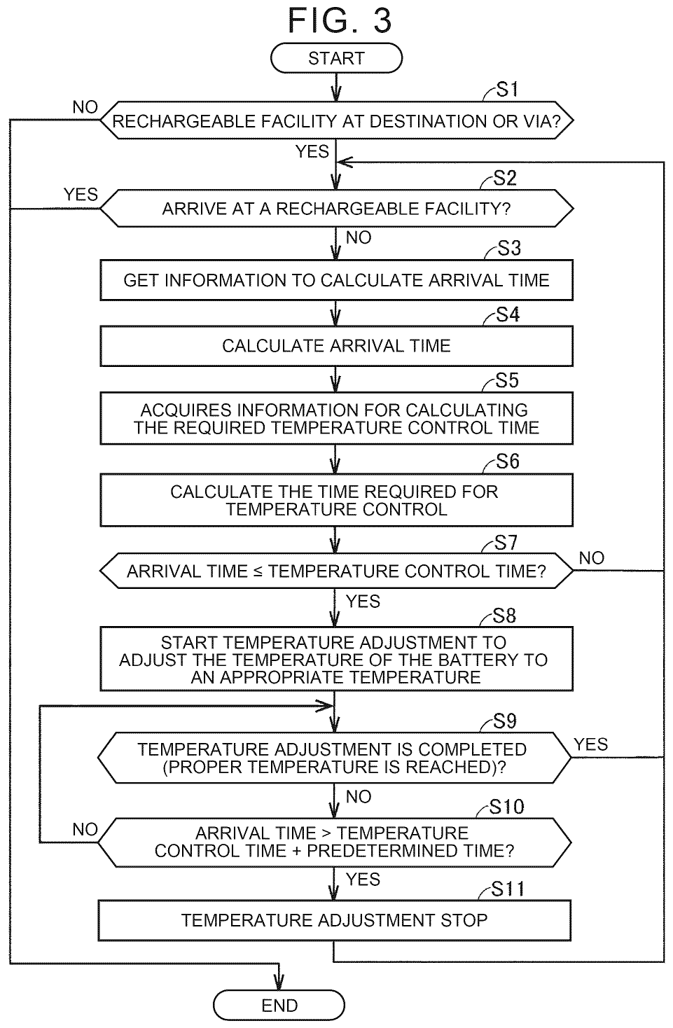

Next, referring to FIG. 3, a control flow related to the temperature adjustment of the power storage device 20 by ECU 10 (processor 1) will be described. Note that the control of ECU 10 according to the present disclosure is not limited to the flowchart shown in FIG. 3. For example, the order of steps may be changed within a feasible range, or any of the steps may be omitted.

In S1, ECU 10 determines whether a chargeable facility is set at a destination or a waypoint in HMI device 30. If a rechargeable establishment has been set (Yes in S1), the process proceeds to S2. If no rechargeable facilities have been set (No in S1), the process ends. Note that S1 determination process may be executed every time the destination (transit point) is set in HMI device 30.

In S2, ECU 10 determines whether an electrified vehicle 100 has arrived at a rechargeable facility set at a destination or a waypoint in S1. ECU 10 determines whether electrified vehicle 100 has arrived at a rechargeable facility, for example, using a global positioning system (GPS) (not shown) module mounted on electrified vehicle 100. GPS module may be mounted on HMI device 30 (car navigation device). If electrified vehicle 100 arrives at the rechargeable establishment (Yes in S2), the process ends. If electrified vehicle 100 has not arrived at the rechargeable establishment (No in S2), the process proceeds to S3.

In S3, ECU 10 obtains, through the terminal 1a (see FIG. 2), information for calculating the required arrival time. In S4, ECU 10 uses S3 data to calculate the time-to-arrive. Note that the calculation of the arrival time is continuously performed until the processing of the flow of FIG. 3 ends.

In addition, the time required for arrival may be calculated in HMI device 30 (such as a car navigation device), and the time required for arrival may be transmitted from HMI device 30 to ECU 10. Here, the information transmitted from HMI device 30 is an exemplary “information based on the first time”.

In S5, ECU 10 acquires information for calculating the required temperature adjustment time through the terminal 1b (see FIG. 2). In S6, ECU 10 uses S5 data to calculate the time required for temperature control. Note that the calculation of the required temperature control time is continuously executed until the processing of the flow of FIG. 3 is completed.

In addition, the time required for temperature control may be calculated in the power storage device 20 (such as a battery ECU), and the time required for temperature control may be transmitted from the power storage device 20 to ECU 10. In this case, the information transmitted from the power storage device 20 is an example of “information based on the second time”.

In S7, ECU 10 determines whether or not the length of the arrival required time calculated in S4 is equal to or less than the length of the temperature adjustment required time calculated in S6. If the length of the arrival required time is equal to or less than the length of the temperature control required time (Yes in S7), the process proceeds to S8. If the arrival time is greater than the temperature control time (No in S7), the process returns to S2.

In S8, ECU 10 starts adjusting the temperature of the power storage device 20 so that the temperature of the power storage device 20 becomes the appropriate temperature. Specifically, ECU 10 starts temperature adjustment (for example, temperature increase) of the power storage device 20 by starting control of the temperature adjustment device 50 (such as heaters).

Note that ECU 10 may reduce the power of the temperature adjustment device 50 so that the time required for temperature adjustment approaches (e.g., becomes equal to) the time required for arrival.

In S9, ECU 10 determines whether or not the temperature control started in S8 has been completed because the temperature of the power storage device 20 has reached an appropriate temperature. If the thermal conditioning is complete (Yes in S9), the process returns to S2. If the temperature adjustment is not completed (No in S9), the process proceeds to S10.

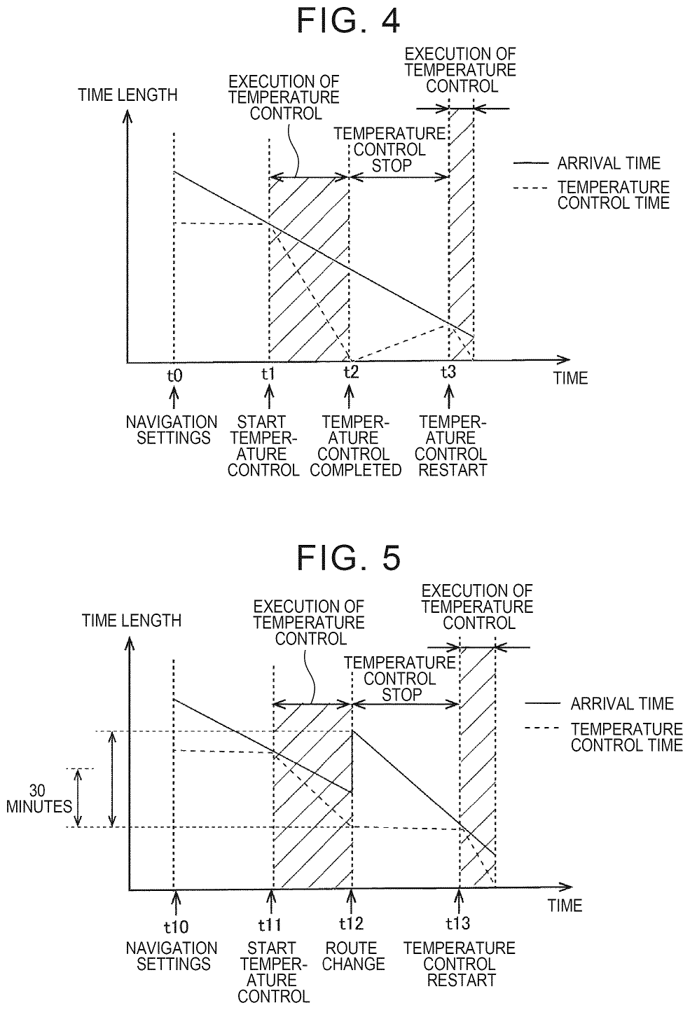

FIG. 4 is a diagram illustrating a change between a required arrival time and a required temperature adjustment time when the temperature adjustment is completed in S9. In the embodiment illustrated in FIG. 4, the chargeable facilities are set to the destination or the waypoint in the time t0. In the time t1, the temperature of the power storage device 20 is started to be adjusted in response to the arrival required time being less than or equal to the temperature control required time. Then, the temperature adjustment of the power storage device 20 is executed, and thus the temperature adjustment of the power storage device 20 is completed at the time t2 prior to the arrival of electrified vehicle 100 at the chargeable facility. After that, ECU 10 stops adjusting the temperature of the power storage device 20.

Due to the fact that the temperature control of the power storage device 20 is stopped at the time t2, the difference between the temperature of the power storage device 20 and the appropriate temperature gradually increases, and accordingly, the time required for temperature control also gradually increases. Then, at the time t3, the arrival required time becomes equal to or less than the temperature control required time. Thus, ECU 10 starts the control of the temperature adjustment device 50 and restarts the temperature adjustment of the power storage device 20 so that the temperature of the power storage device 20 becomes an appropriate temperature at the time t3.

Referring back to FIG. 3, in S10, ECU 10 determines whether the length of the arrival time is greater than the sum of the temperature control time and the predetermined time (e.g., 30 minutes). If the length of the arrival duration is greater than the sum length (Yes in S10), the process proceeds to S11. If the length of the arrival duration is less than or equal to the sum length (No in S10), the process returns to S9. The case where the length of the arrival required time is larger than the total length includes a case where a chargeable facility set as a destination or a waypoint is changed, and the like. The case where the length of the arrival required time is larger than the total length includes a case where the distance to the chargeable facility is changed, for example, in a case where the route to the chargeable facility is changed. The predetermined time may be a time other than 30 minutes. The predetermined time may be a fixed value set in advance or may be appropriately calculated by the processor 1 based on predetermined information.

In S11, ECU 10 stops the temperature adjustment of the power storage device 20. Thereafter, the process returns to S2.

FIG. 5 is a diagram illustrating a change between an arrival required time and a temperature control required time when the length of the arrival required time becomes larger than the total length in S10. In the embodiment illustrated in FIG. 5, the chargeable facilities are set to the destination or the waypoint in the time t10. In the time t11, the temperature of the power storage device 20 is adjusted in response to the arrival required time being less than or equal to the temperature control required time.

Thereafter, in the time t12, the length of the required arrival time is larger than the total length based on the route change to the chargeable facilities or the like. In this situation, ECU 10 stops the temperature adjustment of the power storage device 20. In the embodiment illustrated in FIG. 5, ECU 10 resumes the temperature control of the power storage device 20 at the time t13 when the arrival required time becomes equal to or less than the temperature control required time again.

As described above, in the present embodiment, when the length of the arrival required time is equal to or less than the length of the temperature adjustment required time, ECU 10 starts adjusting the temperature of the power storage device 20 so that the temperature of the power storage device 20 becomes an appropriate temperature. As a result, the temperature of the power storage device 20 can be brought close to an appropriate temperature (reached) before electrified vehicle 100 performs charging in the chargeable facilities. As a result, the charging efficiency of the power storage device 20 can be increased. In addition, it is possible to suppress the temperature adjustment of the power storage device 20 being performed when the length of the arrival required time is larger than the length of the temperature adjustment required time. As a result, it is possible to suppress the temperature adjustment of the power storage device 20 being performed excessively for a long period of time. As a result, it is possible to suppress the deterioration of the electric power cost of electrified vehicle 100.

Further, in the present embodiment, ECU 10 stops the temperature adjustment of the power storage device 20 when the length of the arrival required time becomes larger than the total length of the temperature adjustment required time and the predetermined time due to the change in the length of the arrival required time after the temperature adjustment is started. Accordingly, in a case where the arrival required time becomes long due to a route change to the chargeable facility, a change to the chargeable facility scheduled to be charged, or the like, it is possible to suppress the temperature adjustment of the power storage device 20 being continued and the time of the temperature adjustment from becoming excessively long.

In the above-described embodiment, ECU 10 of electrified vehicle 100 performs the control of the temperature adjusting of the power storage device 20. However, the present disclosure is not limited thereto. Servers or the like provided outside electrified vehicle 100 may execute the above control.

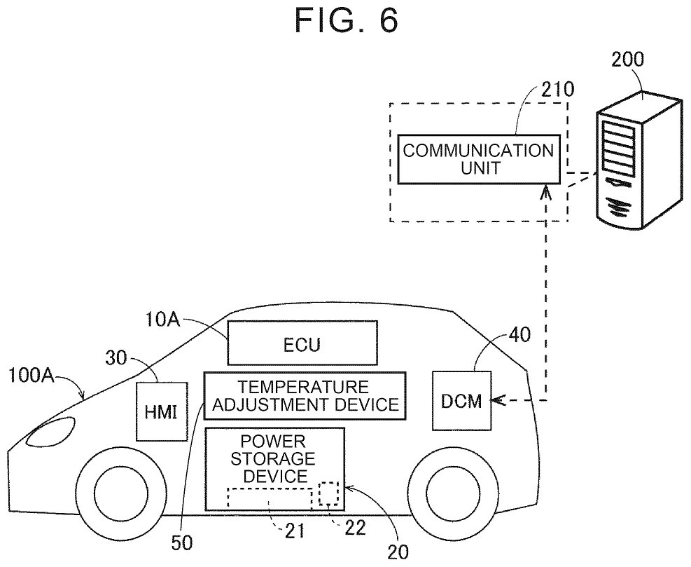

In the embodiment illustrated in FIG. 6, the server 200 includes a communication unit 210 that communicates with DCM 40 of electrified vehicle 100A. The server 200 receives, from electrified vehicle 100A, the position information of electrified vehicle 100A, the information of the destination (waypoint), the information for calculating the required arrival time, the information for calculating the required temperature adjustment time, and the like from the communication unit 210. The server 200 transmits a command for executing (or stopping) the temperature adjustment of the power storage device 20 (executing the control flow of FIG. 3) to electrified vehicle 100A based on the plurality of pieces of information received from electrified vehicle 100A. ECU 10A of electrified vehicle 100A is not controlled with respect to the temperature adjustment of the power storage device 20. Note that the server 200 is an example of a “control device” of the present disclosure. In this case, the communication unit 210 is an example of the “first acquisition unit” and the “second acquisition unit” of the present disclosure. Note that a communication unit (first acquisition unit) that receives information for calculating the arrival required time and a communication unit (second acquisition unit) that receives information for calculating the temperature control required time may be separately provided in the server.

Note that the server 200 may receive only a part of the plurality of pieces of information received from electrified vehicle 100A. That is, some of the steps in FIG. 3 may be performed by electrified vehicle 100A, and the remaining steps may be performed by the server 200. For example, the calculation of the arrival time and the temperature adjustment time may be performed by the server 200. In addition, electrified vehicle 100A that has received the information of the arrival required time and the temperature adjustment required time from the server 200 may execute the control of the temperature adjustment. DCM 40 corresponds to the “first acquisition unit” and the “second acquisition unit” of the present disclosure.

In the above embodiment, the arrival time required for electrified vehicle 100 to arrive at the chargeable facility is used as the time until the charging is executed. For example, the time until the time at which the charging is reserved may be used as the information of the time until the charging is executed. In addition, the sum of the arrival time and the predetermined time (for example, the time required to prepare for charging in the chargeable facility) may be used as information on the time until charging is executed. That is, the temperature adjustment of the power storage device 20 may be started when the total length is equal to or less than the required temperature adjustment time.

In the above embodiment, an example has been described in which the temperature adjustment of the power storage device 20 is started again when the length of the arrival required time becomes equal to or less than the length of the temperature adjustment required time after the temperature adjustment of the power storage device 20 is completed, but the present disclosure is not limited thereto. After the temperature adjustment of the power storage device 20 is completed, the temperature adjustment of the power storage device 20 may not be resumed until it arrives at the chargeable facility.

In the above embodiment, the terminal 1a for receiving the information for calculating the arrival time and the terminal 1b for receiving the information for calculating the temperature adjustment time are separately provided in the processor 1, but the present disclosure is not limited thereto. Each of the information for calculating the arrival required time and the information for calculating the temperature control required time may be received by a common terminal provided in the processor.

In the above-described embodiment, the power storage device 20 is temperature adjusted based on the destination or waypoint information inputted to HMI device 30 (car navigation device). For example, the temperature adjustment of the power storage device 20 may be performed on the basis of the information of the destination or the waypoint input in the mobile terminal (smartphone or the like) of the user.

In the above embodiment, the temperature adjustment is started when the arrival required time is equal to or less than the temperature adjustment required time (refer to S7 of FIG. 3), but the present disclosure is not limited thereto. The temperature adjustment may be started when the arrival required time is equal to or less than the sum of the temperature adjustment required time and the predetermined time (for example, 30 minutes).

Note that the configurations (processes) of the above-described embodiments and the above-described modification examples may be combined with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A control device that controls a vehicle equipped with a chargeable battery, comprising:
a first acquisition unit that acquires information based on a first time until a time at which execution of charging is predicted; and
a second acquisition unit that acquires information based on a second time required to adjust a temperature of the battery to an appropriate temperature that is appropriate for the charging, wherein the vehicle is caused to start temperature adjustment of the battery so that the temperature of the battery becomes the appropriate temperature when a length of the first time based on the information acquired by the first acquisition unit is equal to or less than a length of the second time based on the information acquired by the second acquisition unit.

2. The control device according to claim 1, wherein the vehicle is caused to stop the temperature adjustment when the length of the first time becomes greater than a total length of the second time and a predetermined time due to a change in the length of the first time after the temperature adjustment is started.

3. The control device according to claim 1, wherein the vehicle is caused to start the temperature adjustment again when the length of the first time becomes equal to or less than the length of the second time again after the temperature adjustment is completed.

4. The control device according to claim 1, wherein the first time includes information on a time required for the vehicle to reach a facility capable of the charging.

5. A vehicle comprising:
a chargeable battery; and
the control device according to claim 1.
